(19) United States
(12) Patent Application Publication
(10) Pub. No.: US 2008/0101825 A1
(43) Pub. Date: May 1, 2008

(54) Fixing Unit and Image Forming Apparatus Using the Same

(75) Inventor: Makoto SATO, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/924,162

(22) Filed: Oct. 25, 2007

(30) Foreign Application Priority Data
Oct. 30, 2006 (JP) 2006-293648
Oct. 30, 2006 (JP) 2006-293649

(51) Int. Cl. G03G 15/20

(52) U.S. Cl. 399/322

(57) ABSTRACT

A fixing unit comprises: fixing means including a heating rotator having a heat generator and a pressure rotator which is so disposed opposite to the heating rotator as to form a nip portion, at least one of the heating rotator and pressure rotator having a reversed crown shape; and a post-fixing roller which is disposed on the downstream side relative to the heating rotator and pressure rotator, wherein the feeding force of the post-fixing roller is larger at the width direction both end-sides of the post-fixing roller than at the center portion thereof.

### CROSS-REFERENCE TO RELATED APPLICATIONS

This application is based upon and claims the benefit of priority from prior Japanese Patent Applications No. 2006-293648, filed Oct. 30, 2006 and No. 2006-293649, filed Oct. 30, 2006, the entire contents of which are incorporated herein by reference.

### BACKGROUND OF THE INVENTION

1. Field of the Invention

The present invention particularly relates to a fixing unit capable of preventing waving of a transfer medium immediately after heat fixing of a toner image thereonto and an image forming apparatus using the fixing unit.

2. Description of the Related Art

Generally, a toner image forming means of an electrophotographic type includes a photoconductor serving as an image carrier and having a photosensitive layer on the outer circumferential surface thereof, a charge means for uniformly charging the outer circumferential surface of the photoconductor, an exposure means for selectively exposing the uniformly charged outer circumferential surface to form an electrostatic latent image, and a development means for supplying toner which is developer to the electrostatic latent image formed by the exposure means to form a visible image (toner image).

As an image forming apparatus of a rotary type for forming a color image, there is known an intermediate transfer belt type color image forming apparatus, in which the toner image forming means as described above is disposed opposite to an intermediate transfer belt. In this configuration, toner images on the photoconductors formed by the toner image forming means are sequentially transferred onto the intermediate transfer belt to superimpose toner images of a plurality of colors (e.g., yellow, cyan, magenta, and black) on the intermediate transfer belt, whereby a color image is obtained on the intermediate transfer belt.

As a fixing unit of the image forming apparatus having the configuration described above, there is known one consisting of a fixing roller, a pressure roller which forms a nip which pressing the fixing roller, and a recording medium guide member. The recording medium guide member exists toward the pressure roller side from a line normal to a line passing the nip and connecting the centers of the fixing roller and the pressure roller, and the opposite side of the recording medium guide member is opened. This configuration does not cause wavy wrinkles on a recording medium, prevents curl of the medium from becoming wide, and can easily perform jam processing (see, for example, JP-A-5-6117).

Further, there is known a fixing unit having the following configuration in order to relatively and more strongly applying tension on the width direction center of a recording sheet, which is image-fixed between a heating roller having a reversed crown shape and a pressure roller having a uniform diameter and supplied therefrom, than on the width direction end part of the paper by using a sheet discharging means for discharging the recording sheet toward the downstream side. That is, (1) the circumferential velocity of central driving rollers is made faster than that of side driving rollers; (2) the pressing force of driven rollers against the driving rollers is made stronger at the width direction center position of the recording sheet; or (3) the arrangement interval between the central driving rollers is made smaller than the average arrangement interval. With the above configuration (1), (2), or (3), it is possible to prevent transversal rib-like wrinkles of the recording sheet and waving (see, for example, JP-A-5-40428).

However, in the invention disclosed in JP-A-5-6117, there is not provided a post-fixing roller, so that there is always friction between the recording sheet and guide member, which may cause prints to have an uneven gloss and make a scratch on the prints due to toner sticking to the guide member. In addition, generation of a lot of paper powder may cause adhesion of a clump of toner and paper powder to the recording sheet or cause deposition the above clump on a thermistor to lead to a temperature detection error.

Further, in the invention disclosed in JP-A-5-40428, when the feeding force of the fixing roller is made larger than that of the post-fixing roller in order to cover the feeding force of the reversed crown shaped roller which becomes short at the width direction center portion of the recording sheet, extreme settings are required, which may cause excessive abrasion of the post-fixing roller and cause a print image to have an uneven gloss.

### SUMMARY OF THE INVENTION

The present invention has been made in view of the above problems resided in prior arts, and an object thereof is to provide a fixing unit capable of reducing waving of a transfer medium which is caused due to a reversed crown shape of a fixing roller and an image forming apparatus using the fixing unit.

To achieve the above object, a fixing unit according to the present invention includes: a fixing means including a heating rotator having a heat generator and a pressure rotator which is so disposed opposite to the heating rotator as to form a nip portion, at least one of the heating rotator and pressure rotator having a reversed crown shape; and a post-fixing roller which is disposed on the downstream side relative to the heating rotator and pressure rotator. The feeding force of the post-fixing roller is larger at the width direction both end-sides of the post-fixing roller than at the center portion thereof. With this configuration, waving of a transfer medium caused due to the fixing roller having a reversed crown shape can be reduced.

The post-fixing roller has both-end-side post-fixing rollers respectively disposed on its width direction both end-sides and central post-fixing rollers disposed at its width direction center portion, and the arrangement interval of each of the both-end-side post-fixing rollers is smaller than that of the central post-fixing rollers. With this configuration, waving of a transfer medium caused due to the fixing means having a reversed crown shape can be reduced.

The post-fixing roller has both-end-side post-fixing rollers respectively disposed on its width direction both end-sides and central post-fixing rollers disposed at its width direction center portion, and the outer diameters of the both-end-side post-fixing rollers are larger than those of the central post-fixing rollers. With this configuration, waving of a transfer medium caused due to the fixing means having a reversed crown shape can be reduced.

The post-fixing roller has both-end-side post-fixing rollers respectively disposed on its width direction both end-sides and central post-fixing rollers disposed at its width direction center portion, and the frictional forces of the both-end-side post-fixing rollers are larger than those of the central post-fixing rollers. With this configuration, waving of a transfer medium caused due to the fixing means having a reversed crown shape can be reduced.

The post-fixing roller has both-end-side post-fixing rollers respectively disposed on its width direction both end-sides and central post-fixing rollers disposed at its width direction center portion, and the nip pressures of the both-end-side post-fixing rollers are larger than those of the central post-fixing rollers. With this configuration, waving of a transfer medium caused due to the fixing means having a reversed crown shape can be reduced.

Further, to achieve the above object, a fixing unit according to the present invention includes: a fixing means including a heating rotator having a heat generator and a pressure rotator which is so disposed opposite to the heating rotator as to form a nip portion, at least one of the heating rotator and pressure rotator having a reversed crown shape; a post-fixing roller which is disposed on the downstream side relative to the fixing means; and a post-fixing guide disposed between the fixing means and post-fixing roller. The post-fixing guide has a configuration such that the distance from a fixing nip line connecting a nip exit of the fixing means and nip entrance of the post-fixing roller is larger at the center portion of the post-fixing guide than at the both end-sides thereof. With this configuration, waving of a sheet caused due to the fixing means having a reversed crown shape can be reduced.

The post-fixing guide has a cross-section having a shape such that the distance from a fixing nip line connecting a nip exit of the fixing means and nip entrance of the post-fixing roller is larger at the center portion of the post-fixing guide than at the both end-sides thereof. With this configuration, waving of a sheet caused due to the fixing means having a reversed crown shape can be reduced with a simple structure and at low cost.

The post-fixing guide has, at is center portion, a space allowing for deflection of a transfer medium. With this configuration, waving of a sheet caused due to the fixing means having a reversed crown shape can be reduced with a simple structure and at low cost.

The post-fixing guide has ribs on the guide both end-sides. With this configuration, waving of a sheet caused due to the fixing means having a reversed crown shape can be reduced with a simple structure, as well as the strength of the post-fixing guide can be increased.

The ribs are also provided on the guide center portion, and the length of the ribs on the guide both end-sides are longer than those of the ribs on the guide center portion. With this configuration, waving of a sheet caused due to the fixing means having a reversed crown shape can be reduced with a simple structure, as well as the strength of the post-fixing guide can be increased.

Further, an image forming apparatus using the fixing unit according to the present invention includes: an image carrier; a developer carrier for developing a latent image on the image carrier; an intermediate transfer member for transferring the image on the image carrier developed by the developer carrier; a secondary transfer section for transferring the image on the intermediate transfer member onto a transfer medium; and the fixing unit for fixing the image on the transfer medium. With this configuration, waving of a sheet caused due to the fixing means having a reversed crown shape can be reduced.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

The invention will be described with reference to the accompanying drawings, wherein like numbers reference like elements;

FIG. 1 is a perspective view of a fixing unit according to a first example of a first embodiment;

FIG. 2 is an operational view of the fixing unit according to the first example of the first embodiment;

FIGS. 3A and 3B are a plan view and a cross-sectional view of the fixing unit according to the first example of the first embodiment;

FIGS. 4A, 4B, and 4C are comparison views showing an arrangement of rollers according to the first example of the first embodiment and other arrangement examples;

FIG. 5 is a perspective view of a fixing unit according to a second example of the first embodiment;

FIG. 6 is an operational view of the fixing unit according to the second example of the first embodiment;

FIG. 7 is a plan view of the fixing unit according to the second example of the first embodiment;

FIG. 8 is a perspective view of a fixing unit according to a third example of the first embodiment;

FIG. 9 is an operational view of the fixing unit according to the third example of the first embodiment;

FIG. 10 is a plan view of the fixing unit according to the third example of the first embodiment;

FIG. 11 is a perspective view of a fixing unit according to a fourth example of the first embodiment;

FIG. 12 is an operational view of the fixing unit according to the fourth example of the first embodiment;

FIG. 13 is a plan view of the fixing unit according to the fourth example of the first embodiment;

FIG. 14 is a vertical cross-sectional side view of a fixing unit according to a second embodiment;

FIG. 15 is an operational view of the fixing unit according the second embodiment;

FIG. 16 is an operational view of the fixing unit according the second embodiment;

FIG. 17 is a view showing a first example of a post-fixing guide according to the second embodiment;

FIG. 18 is a view showing a second example of a post-fixing guide according to the second embodiment;

FIG. 19 is a view showing a third example of a post-fixing guide according to the second embodiment;

FIG. 20 is a view showing a fourth example of a post-fixing guide according to the second embodiment;

FIG. 21 is a view showing a fifth example of a post-fixing guide according to the second embodiment; and

FIG. 22 is a vertical cross-sectional side view showing an image forming apparatus according to an embodiment the present invention.

### DETAILED DESCRIPTION OF THE EXEMPLARY EMBODIMENTS

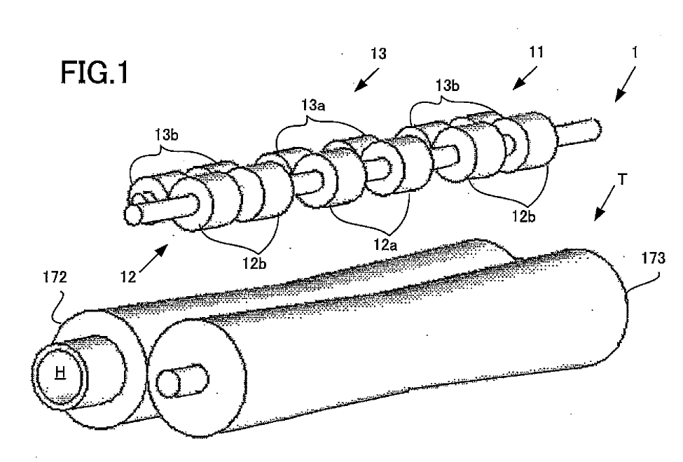

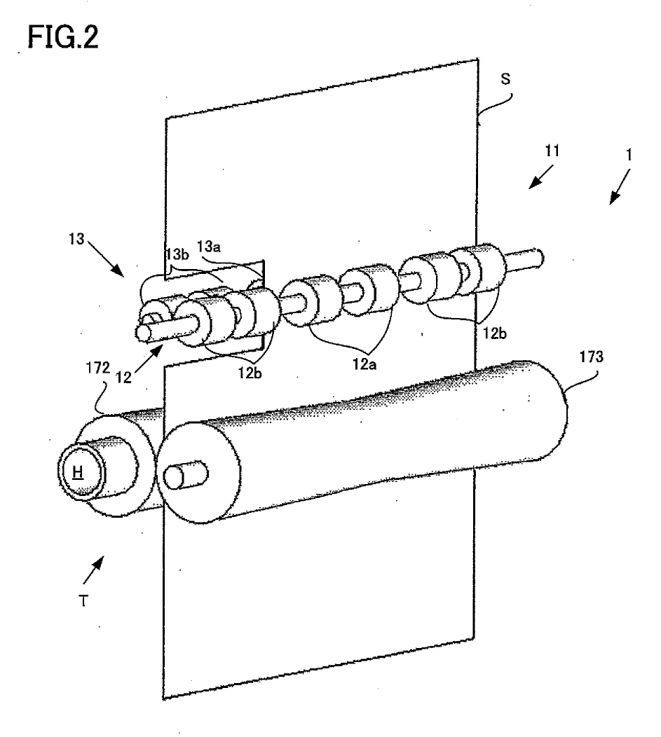

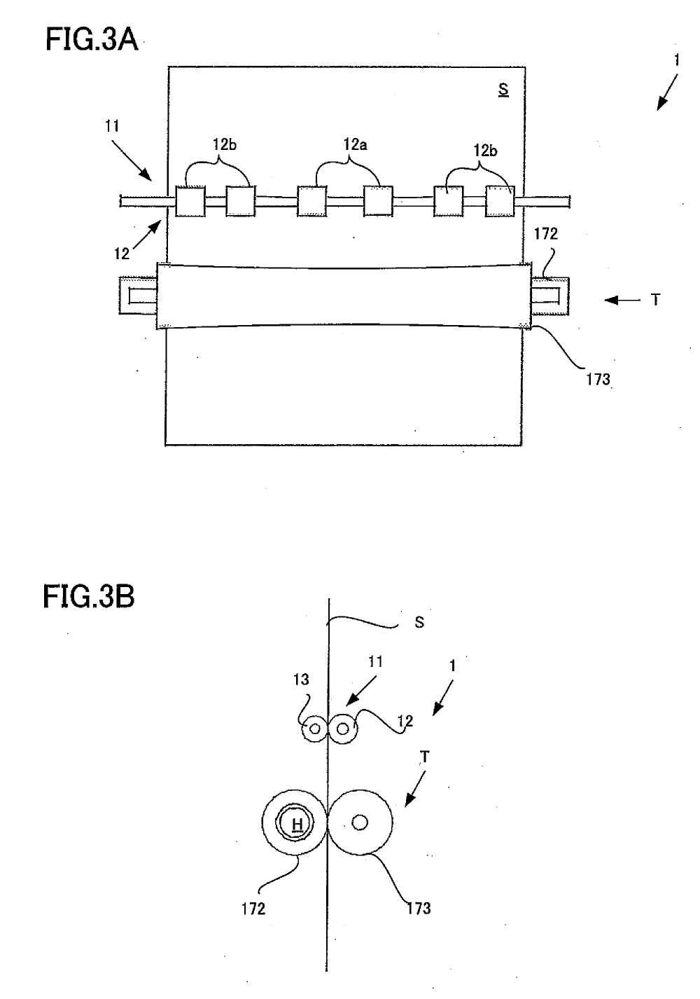

A first embodiment of the present invention will be described below with reference to the accompanying drawings. A fixing unit according to a first example of the first embodiment has a configuration in which the number and arrangement density of end side driving post-fixing rollers 12b are increased relative to central driving post-fixing rollers 12a. FIG. 1 is a perspective view of a fixing unit according to a first example of a first embodiment of the present invention, FIG. 2 is a perspective operational view showing a state where a recording sheet S passes through the fixing unit according to the first example of the first embodiment, and FIGS. 3A and 3B are a plan view and a cross-sectional view showing a state where the recording sheet S passes through the fixing unit according to the first example of the first embodiment. In the drawings, a reference symbol 1 denotes a fixing unit, 11 denotes a post-fixing roller, 12 denotes a driving post-fixing roller, 12a denotes central driving post-fixing rollers, 12b denotes end side driving post-fixing rollers, 13 denotes a driven post-fixing roller, 13a denotes central driven post-fixing rollers, 13b denotes end side driven post-fixing rollers, T denotes a fixing roller, 172 denotes a heating roller, H denotes a heater, 173 denotes a pressure roller, and S denotes a recording sheet serving as a transfer medium.

As shown in FIG. 1, the fixing unit 1 includes the heating roller 172, pressure roller 173, and the like. The heating roller 172 incorporates the heater H and is rotatably supported at its both end portions. The pressure roller 173 is disposed in parallel to the heating roller 172 and has a reversed crown shape in which the outer diameter of each of the both end portions thereof is larger than that of the center portion. Like the heating roller 172, the pressure roller 173 is rotatably supported at its both end portions. The recording sheet S onto which a toner image has been thermally fixed by the heating roller 172 is fed from between the heating roller 172 and pressure roller 173 and, then, is discharged toward the downstream side by the post-fixing roller 11.

The post-fixing roller 11 includes the driving post-fixing roller 12 provided on one side of the recording sheet S, driven post-fixing roller 13 which is disposed opposite to the driving post-fixing roller 12 on the other side of the recording sheet S, and a not shown post-fixing roller driving means.

The driving post-fixing roller 12 includes two central driving post-fixing rollers 12a disposed at the center portion in the width direction of the recording sheet S and four end side driving post-fixing rollers composed of two first end side driving post-fixing rollers 12b and two second end side driving post-fixing rollers 12c disposed respectively on the width direction both end-sides. The central driving post-fixing rollers 12a and first end side driving post-fixing rollers 12b are integrally driven by a not shown post-fixing roller driving means. The arrangement interval of each of the end side driving post-fixing rollers is smaller than that of the central driving post-fixing rollers 12a. The driven post-fixing roller 13 includes two central driven post-fixing rollers 13a disposed at the center portion in the width direction of the recording sheet S and four end side driven post-fixing rollers composed of two first end side drive post-fixing rollers 13b and two second end side driven post-fixing rollers 13c which are disposed opposite respectively to the first end side driving post-fixing rollers 12b and second end side driving post-fixing rollers 12c. As in the case of the driving rollers, the arrangement interval of each of the end side driven post-fixing rollers is smaller than that of the central driven post-fixing rollers 13a. The driven post-fixing roller 13 is pressed against the driving post-fixing roller 12 and is driven by the driving post-fixing roller 12 so as to be rotated.

As shown in FIGS. 2 and 3, in the fixing unit having the configuration described above, the heating roller 172 is heated by the heater H and feeds the recording sheet S to the post-fixing roller 11 while holding the recording sheet S between itself and pressure roller 173. At this time, the feeding amount of the recording sheet S is smaller at the width direction center portion due to the reversed crown shape of the pressure roller 173 while the feeding amount thereof is larger at the both end-sides. This difference in the feeding amount causes the both end-sides of the recording sheet S to get loose at the downstream side of the pressure roller 173, which may generate wrinkles in the recording sheet S.

Subsequently, as shown in FIGS. 2 and 3, the recording sheet S is fed between the driving post-fixing roller 12 and driven post-fixing roller 13. At this time, since the arrangement interval of each of the first and second end side driving post-fixing rollers and arrangement interval of each of the first and second end side driven post-fixing rollers are smaller than those of the central driving and driven rollers 12a and 13a as shown in FIG. 3A, the recording sheet S is fed in such a manner as to be expanded from the center toward both end portions. Therefore, looseness of the recording sheet S at both end-sides thereof which is generated between the heating and pressure rollers 172, 173 and post-fixing roller 11 can be reduced.

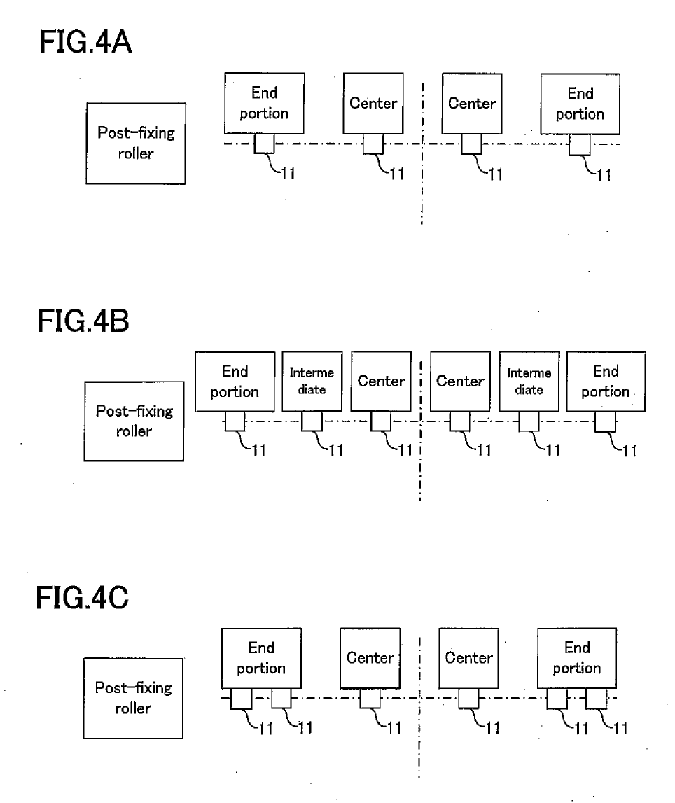

FIGS. 4A, 4B, and 4C are comparison views showing an arrangement of rollers according to the first example of the first embodiment and other arrangement examples. FIG. 4A shows a case where four post-fixing rollers 11 are equally spaced, FIG. 4B shows a case where six post-fixing rollers 11 are arranged such that two sets of three post-fixing rollers 11 are equally spaced respectively on the width direction both sides, and FIG. 4C shows an arrangement according to the first embodiment. The following table 1 shows a result of tests regarding a waving state at the end portions of the recording sheet S in the above three cases.

TABLE 1

| | | | Post-fixing | | |
|---|---|---|---|---|---|
| | Post-fixing | | Roller feeding | | Waving at |
| Fixing roller sheet | roller speed | | force | | Sheet end |
| feeding speed: 0% | End | Center | End | Center | portion |
| Case of FIG. 4A | +1.5% | +1.5% | 3N | 3N | X |
| Case of FIG. 4B | +1.5% | +1.5% | 3N | 3N | Δ |
| Case of FIG. 4C | +1.5% | +1.5% | 3N | 3N | ◯ |
| (First embodiment) | | | | | |

The “post-fixing roller feeding force” means a force required for the post-fixing roller 11 to pinch and pull out the recording sheet S by a tension gauge.

Although the feeding speed and feeding force of the post-fixing roller 11 are the same between the above three cases as described above, when the post-fixing roller 11 is arranged such that the number and arrangement density of end side post-fixing rollers are increased relative to central post-fixing rollers, waving of the recording sheet S at its end portions can be reduced.

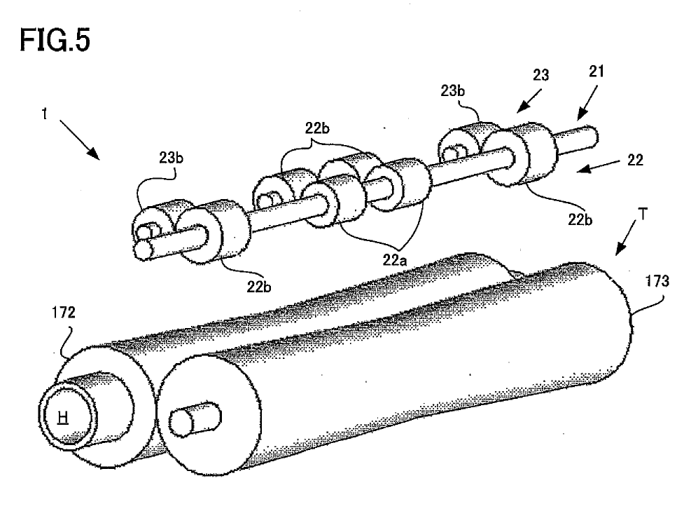

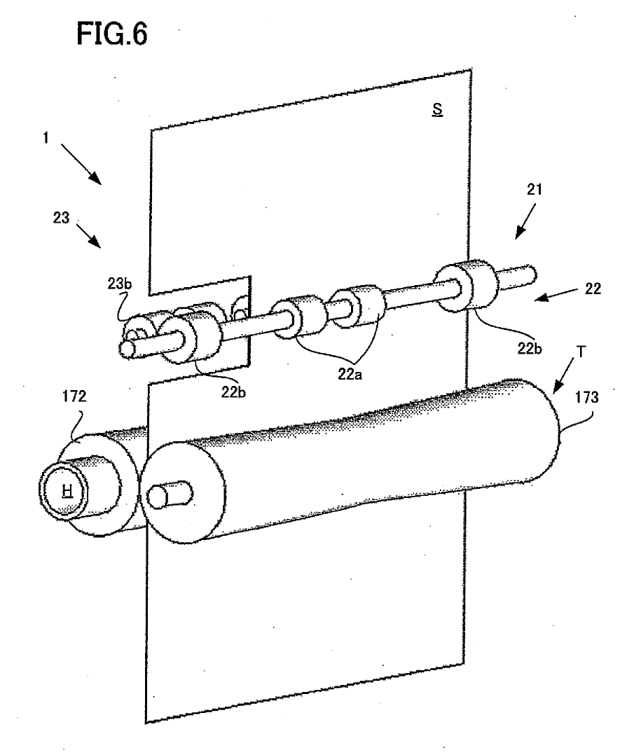

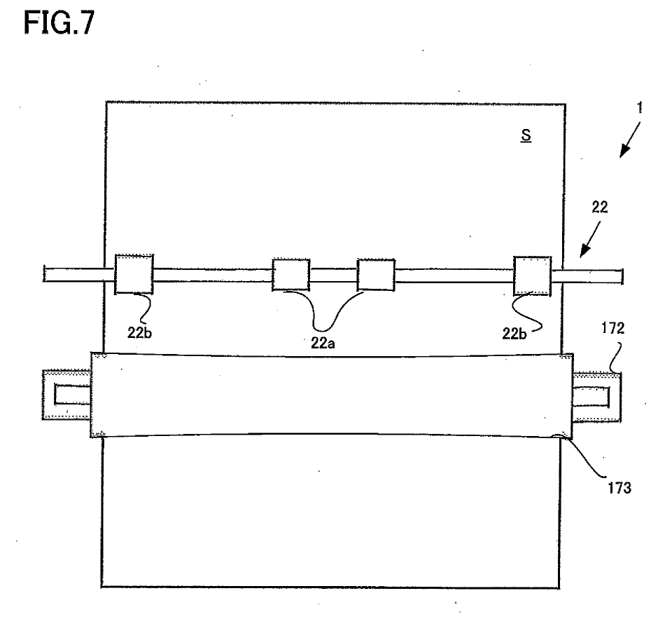

Next, a second example of the first embodiment will be described. A fixing unit according to the second example of the first embodiment has a configuration in which outer diameters of the end side driving post-fixing rollers 22b are made larger than those of central driving post-fixing rollers 22a. FIG. 5 is a perspective view of a fixing unit according to the second example of the first embodiment, FIG. 6 is a perspective view showing a state where the recording sheet S passes through the fixing unit according to the second example of the first embodiment, and FIG. 7 is a plane view showing a state where the recording sheet S passes through the fixing unit according to the second example of the first embodiment. In the drawings, a reference symbol 21 denotes a post-fixing roller, 22 denotes a driving post-fixing roller, 22a denotes central driving post-fixing rollers, 22b denotes end side driving post-fixing rollers, 23 denotes a driven post-fixing roller, 23a denotes central driven post-fixing rollers, 23b denotes end side driven post-fixing rollers, T denotes a fixing roller, 172 denotes a heating roller, H denotes a heater, and 173 denotes a pressure roller.

The heating roller 172 incorporates the heater H and is rotatably supported at its both end portions. The pressure roller 173 is disposed in parallel to the heating roller 172 and has a reversed crown shape in which the outer diameter of each of the both end portions thereof is larger than that of the center portion. Like the heating roller 172, the pressure roller 173 is rotatably supported at its both end portions. The recording sheet S onto which a toner image has been thermally fixed by the heating roller 172 is fed from between the heating roller 172 and pressure roller 173 and, then, is discharged toward the downstream side by the post-fixing roller 21.

The post-fixing roller 21 includes the driving post-fixing roller 22 provided on one side of the recording sheet S, the driven post-fixing roller 23 which is disposed opposite to the driving post-fixing roller 22 on the other side of the recording sheet S, and a not shown post-fixing roller driving means and is made of an elastic member.

The driving post-fixing roller 22 includes two central driving post-fixing rollers 22a disposed at the center portion in the width direction of the recording sheet S and two end side driving post-fixing rollers 22b disposed, one by one, on the width direction both end-sides. The central driving post-fixing rollers 22a and end side driving post-fixing rollers 22b are integrally driven by a not shown post-fixing roller driving means. The outer diameters of the end side driving post-fixing rollers 22b are larger than those of the central driving post-fixing rollers 22a.

The driven post-fixing roller 23 includes two central driven post-fixing rollers 23a disposed at the center portion in the width direction of the recording sheet S and two end side driven post-fixing rollers 23b disposed, one by one, on the width direction both end-sides. The driven post-fixing roller 23 is pressed against the driving post-fixing roller 22 by a not shown pressing means such as a spring and is driven by the driving post-fixing roller 22 so as to be rotated.

As shown in FIGS. 6 and 7, in the fixing unit having the configuration described above, the heating roller 172 is heated by the heater H and feeds the recording sheet S to the post-fixing roller 21 while holding the recording sheet S between itself and pressure roller 173. At this time, the feeding amount of the recording sheet S is smaller at the width direction center portion due to the reversed crown shape of the pressure roller 173 while the feeding amount thereof is larger at the both end-sides. This difference in the feeding amount causes the both end-sides of the recording sheet S to get loose at the downstream side of the pressure roller 173, which may generate wrinkles in the recording sheet S.

Subsequently, the recording sheet S is fed between the driving post-fixing roller 22 and driven post-fixing roller 23. At this time, since the outer diameters of the end side driving post-fixing rollers 22b of the driving post-fixing roller 22 are larger than those of the central driving post-fixing rollers 22a, the sheet feeding amount by the end side driving post-fixing rollers 22b becomes larger than those by the central driving post-fixing rollers 22a. Therefore, looseness of the recording sheet S at both end-sides thereof which is generated between the heating and pressure rollers 172, 173 and post-fixing roller 21 can be reduced.

The following Table 2 shows a result of tests regarding a waving state at the end portions of the recording sheet S in the case where the feeding speed between the central driving post-fixing rollers 22a and end side driving post-fixing rollers 22b is changed in several steps.

TABLE 2

| | | | | | | Roller | Uneven |
|---|---|---|---|---|---|---|---|
| | | | Post-fixing | | | abrasion | gloss |
| Fixing roller | Post-fixing | | Roller feeding | | Waving at | after | at double |
| sheet feeding | Roller speed | | force | | Sheet end | endurance | side |
| speed: 0% | End | Center | End | Center | portion | test | printing |
| No difference | +1.5% | +1.5% | 3N | 3N | X | ◯ | ◯ |
| in feeding | | | | | | | |
| speed (1) | | | | | | | |
| No difference | +3.5% | +3.5% | 3N | 3N | Δ | ◯ | X |
| in feeding | | | | | | | (Center) |
| speed (2) | | | | | | | |
| Difference in | +2.5% | +1.5% | 3N | 3N | Δ | ◯ | ◯ |
| feeding speed | | | | | | | |
| between center | | | | | | | |
| and end is 1% | | | | | | | |
| Difference in | +3.5% | +1.5% | 3N | 3N | ◯ | ◯ | ◯ |
| feeding speed | | | | | | | |
| between center | | | | | | | |
| and end is 2% | | | | | | | |
| Difference in | +4.5% | +1.5% | 3N | 3N | ◯ | ◯ | ◯ |
| feeding speed | | | | | | | |
| between center | | | | | | | |
| and end is 3% | | | | | | | |
| Difference in | +5.5% | +1.5% | 3N | 3N | ◯ | Δ | Δ |
| feeding speed | | | | | | (End) | (End) |
| between center | | | | | | | |
| and end is 4% | | | | | | | |
| Difference in | +6.5% | +1.5% | 3N | 3N | ◯ | X | X |
| feeding speed | | | | | | (End) | (End) |
| between center | | | | | | | |
| and end is 5% | | | | | | | |

Here, the uneven gloss caused at center portion of the recording sheet S will be described. The rotational speed of the post-fixing roller 21 is made higher than that of the fixing roller T in general, so that a slip occurs between the post-fixing roller 21 and recording sheet S. As a result, uneven gloss is likely to occur in a print image especially on the driving post-fixing roller 22 side which is the print contact side at the double side printing time. Further, in a stand-by state (print stand-by state), heat is dissipated from the both end portions of the fixing roller T to bearings and frames, so that the temperature distribution in the axial direction of the fixing roller T is such that the temperature is high at the center portion and the temperature becomes lower at the position closer to each end portion. Similarly, the temperature distribution in the axial direction of the fixing roller T at the time immediately after the printing start time is such that the temperature is high at the center portion. As a result, uneven gloss is likely to occur at the center portion of the recording sheet S.

As shown in Table 2, by providing a rotational speed difference between the central driving post-fixing rollers 22a and end side driving post-fixing rollers 22b, waving of the recording sheet S at its end portions can be reduced. More preferably, the rotational speed difference between the central driving post-fixing rollers 22a and end side driving post-fixing rollers 22b is set to about 2% to 3%. In this case, abrasion and uneven gloss can also be reduced.

Although the outer diameters of the end side driving post-fixing rollers 22b are made larger than those of the central driving post-fixing rollers 22a in this example of the embodiment, the outer diameters of the end side driven post-fixing rollers 23b may be made larger than those of the central driven post-fixing rollers 23a.

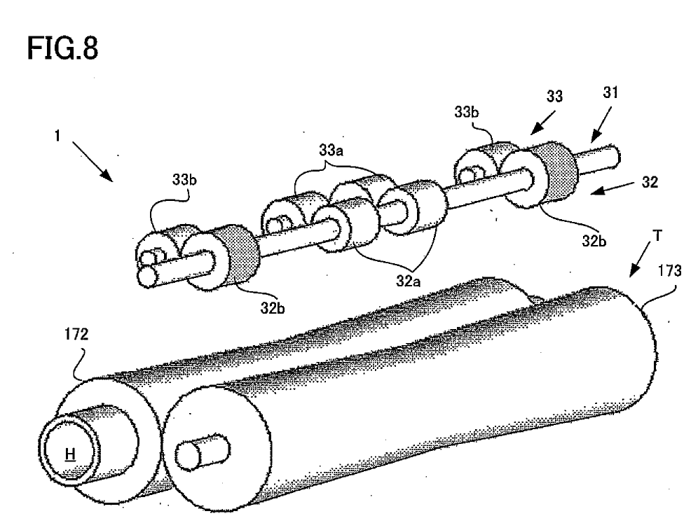

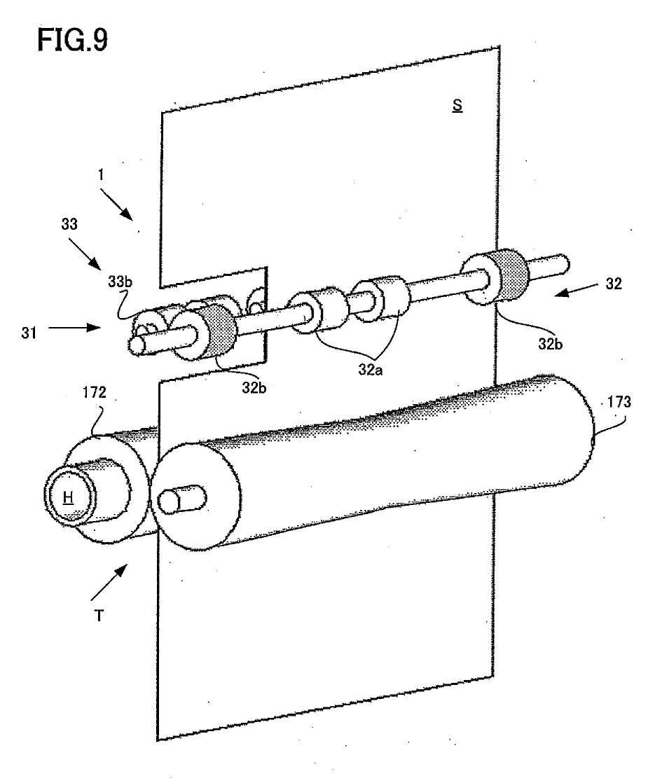

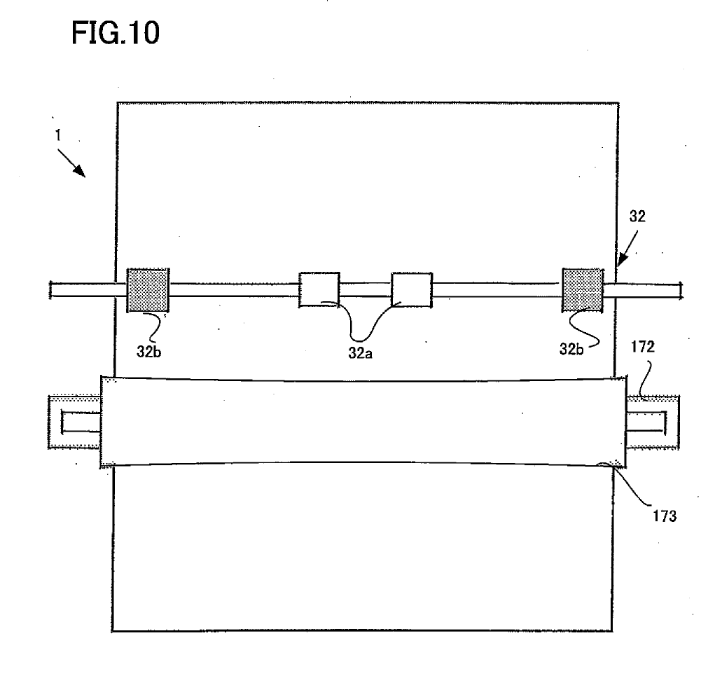

Next, a third example of the first embodiment will be described. A fixing unit according to the third example of the first embodiment has a configuration in which the feeding forces, such as, frictional force, nip pressure, etc., of end side driving post-fixing rollers 32b are made larger than those of central driving post-fixing rollers 32a. FIG. 8 is a perspective view of a fixing unit according to the third example of the first embodiment, FIG. 9 is a perspective view showing a state where the recording sheet S passes through the fixing unit according to the third example of the first embodiment, and FIG. 10 is a plane view showing a state where the recording sheet S passes through the fixing unit according to the third example of the first embodiment. In the drawings, a reference symbol 31 denotes a post-fixing roller, 32 denotes a driving post-fixing roller, 32a denotes central driving post-fixing rollers, 32b denotes end side driving post-fixing rollers, 33 denotes a driven post-fixing roller, 33a denotes central driven post-fixing rollers, 33b denotes end side driven post-fixing rollers, T denotes a fixing roller, 172 denotes a heating roller, H denotes a heater, and 173 denotes a pressure roller.

The heating roller 172 incorporates the heater H and is rotatably supported at its both end portions. The pressure roller 173 is disposed in parallel to the heating roller 172 and has a reversed crown shape in which the outer diameter of each of the both end portions thereof is larger than that of the center portion. Like the heating roller 172, the pressure roller 173 is rotatably supported at its both end portions. The recording sheet S onto which a toner image has been thermally fixed by the heating roller 172 is fed from between the heating roller 172 and pressure roller 173 and, then, is discharged toward the downstream side by the post-fixing roller 31.

The post-fixing roller 31 includes the driving post-fixing roller 32 provided on one side of the recording sheet S, driven post-fixing roller 33 which is disposed opposite to the driving post-fixing roller 22 on the other side of the recording sheet S, and a not shown post-fixing roller driving means.

The driving post-fixing roller 32 includes two central driving post-fixing rollers 32a disposed at the center portion in the width direction of the recording sheet S and two end side driving post-fixing rollers 32b disposed, one by one, on the width direction both end-sides. The central driving post-fixing rollers 32a and end side driving post-fixing rollers 32b are integrally driven by a not shown post-fixing roller driving means. The feeding forces of the end side driving post-fixing rollers 32b are larger than those of the central driving post-fixing rollers 32a.

The driven post-fixing roller 33 includes two central driven post-fixing rollers 33a disposed at the center portion in the width direction of the recording sheet S and two end side driven post-fixing rollers 33b disposed, one by one, on the width direction both end-sides. The driven post-fixing roller 33 is pressed against the driving post-fixing roller 32 by a not shown pressing means such as a spring and is driven by the driving post-fixing roller 32 so as to be rotated.

As shown in FIGS. 9 and 10, in the fixing unit having the configuration described above, the heating roller 172 is heated by the heater H and feeds the recording sheet S to the post-fixing roller 31 while holding the recording sheet S between itself and pressure roller 173. At this time, the feeding amount of the recording sheet S is smaller at the width direction center portion due to the reversed crown shape of the pressure roller 173 while the feeding amount thereof is larger at the both end-sides. This difference in the feeding amount causes the both end-sides of the recording sheet S to get loose at the downstream side of the pressure roller 173, which may generate wrinkles in the recording sheet S.

Subsequently, the recording sheet S is pinched and fed between the driving post-fixing roller 32 and driven post-fixing roller 33. At this time, since the feeding forces of the end side driving post-fixing rollers 32b of the driving post-fixing roller 32 are larger than those of the central driving post-fixing rollers 32a, the feeding amount becomes larger at the both end portions of the recording sheet S. Therefore, looseness of the recording sheet S at both end-sides thereof which is generated between the heating and pressure rollers 172, 173 and post-fixing roller 31 can be reduced.

The following Table 3 shows a result of tests regarding a waving state at the end portions of the recording sheet S in the case where the feeding force between the central driving post-fixing rollers 32a and end side driving post-fixing rollers 32b is changed in several steps.

TABLE 3

| | | | Post-fixing | | | |
|---|---|---|---|---|---|---|
| Fixing roller | Post-fixing | | Roller feeding | | Waving at | Feeding |
| sheet feeding | Roller speed | | force | | Sheet end | stability of |
| speed: 0% | End | Center | End | Center | portion | narrow sheet |
| No difference | +1.5% | +1.5% | 3N | 3.0N | X | ◯ |
| in feeding | | | | | | |
| force | | | | | | |
| Difference in | +1.5% | +1.5% | 3N | 2.0N | Δ | ◯ |
| feeding force | | | | | | |
| between center | | | | | | |
| and end is 1N | | | | | | |
| Difference in | +1.5% | +1.5% | 3N | 1.5N | ◯ | ◯ |
| feeding force | | | | | | |
| between center | | | | | | |
| and end is | | | | | | |
| 1.5N | | | | | | |
| Difference in | +1.5% | +1.5% | 3N | 1.0N | ◯ | ◯ |
| feeding force | | | | | | |
| between center | | | | | | |
| and end is 2N | | | | | | |
| Difference in | +1.5% | +1.5% | 3N | 0.5N | ◯ | X |
| feeding force | | | | | | |
| between center | | | | | | |
| and end is | | | | | | |
| 2.5N | | | | | | |

The “Feeding stability of narrow sheet” means the sheet feeding stability achieved only by the central driving post-fixing rollers 32a.

As described above, by lowering the feeding forces of the central driving post-fixing rollers 32a relative to the end side driving post-fixing rollers 32b, waving of the recording sheet S at its end portions can be reduced.

Although the feeding forces of the end side driving post-fixing rollers 32b are made larger than those of the central driving post-fixing rollers 32a in the above example, either of the feeding forces of the end portion driving post-fixing rollers 32b and the end side driven post-fixing rollers 33b may be made larger than those of the central driving post-fixing rollers 32a and the central driven post-fixing rollers 33a.

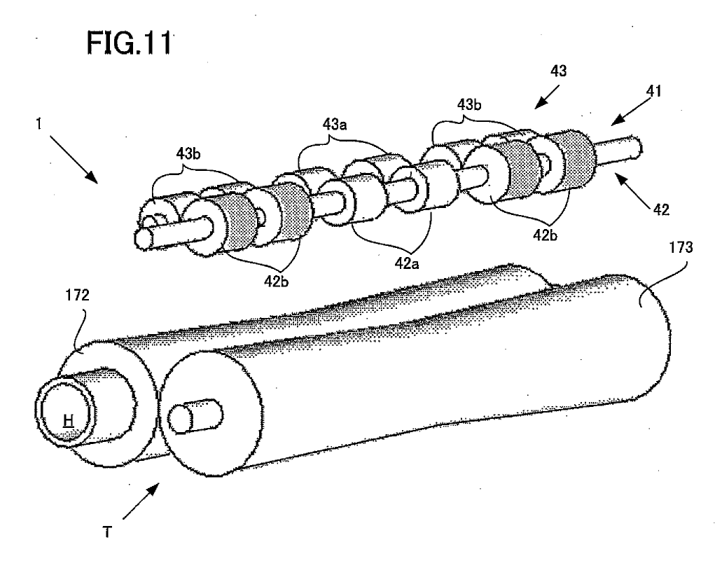

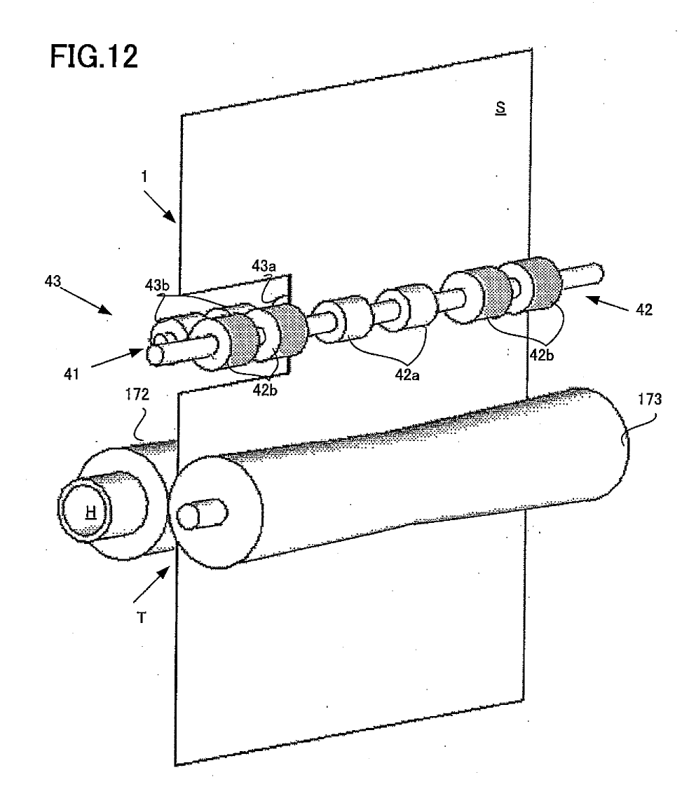

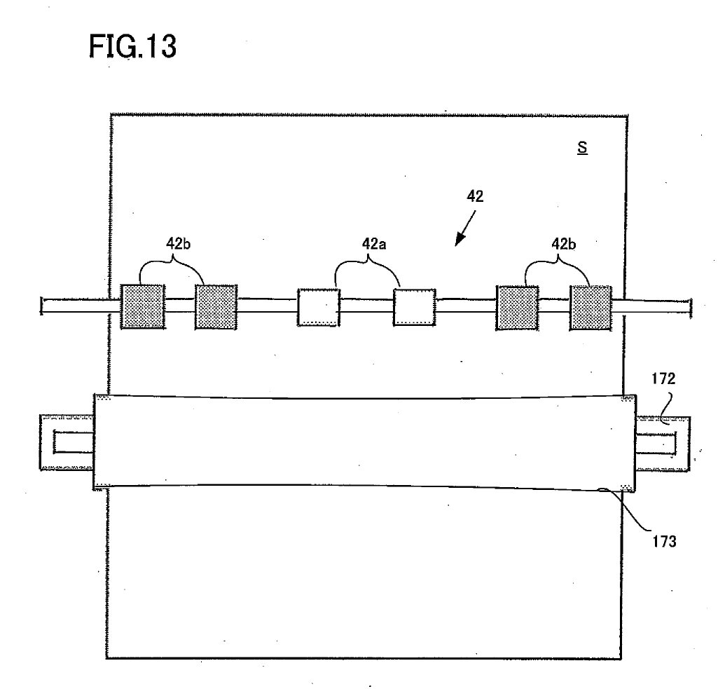

Next, a fourth example of the first embodiment will be described. A fixing unit according to the fourth example of the first embodiment has a configuration obtained by combining the first through third examples of the first embodiment. FIG. 11 is a perspective view of a fixing unit according to the fourth example of the first embodiment, FIG. 12 is a perspective view showing a state where the recording sheet S passes through the fixing unit according to the fourth example of the first embodiment, and FIG. 13 is a plan view showing a state where the recording sheet S passes through the fixing unit according to the fourth example of the first embodiment. In the drawings, a reference symbol 41 denotes a post-fixing roller, 42 denotes a driving post-fixing roller, 42a denotes central driving post-fixing rollers, 42b denotes end side driving post-fixing rollers, 43 denotes a driven post-fixing roller, 43a denotes central driven post-fixing rollers, 43b denotes end side driven post-fixing rollers, T denotes a fixing roller, 172 denotes a heating roller, H denotes a heater, and 173 denotes a pressure roller.

The heating roller 172 incorporates the heater H and is rotatably supported at its both end portions. The pressure roller 173 is disposed in parallel to the heating roller 172 and has a reversed crown shape in which the outer diameter of each of the both end portions thereof is larger than that of the center portion. Like the heating roller 172, the pressure roller 173 is rotatably supported at its both end portions. The recording sheet S onto which a toner image has been thermally fixed by the heating roller 172 is fed from between the heating roller 172 and pressure roller 173 and, then, is discharged toward the downstream side by the post-fixing roller 41.

The post-fixing roller 41 includes the driving post-fixing roller 42 provided on one side of the recording sheet S, driven post-fixing roller 43 which is disposed opposite to the driving post-fixing roller 22 on the other side of the recording sheet S, and a not shown post-fixing roller driving means.

The driving post-fixing roller 42 includes two central driving post-fixing rollers 42a disposed at the center portion in the width direction of the recording sheet S and four end side driving post-fixing rollers 42b disposed, two by two, on the width direction both end-sides. The central driving post-fixing rollers 42a and end side driving post-fixing rollers 42b are integrally driven by a not shown post-fixing roller driving means. The outer diameters and frictional forces of the end side driving post-fixing rollers 42b are larger than those of the central driving post-fixing rollers 42a.

The driven post-fixing roller 43 includes two central driven post-fixing rollers 43a disposed at the center portion in the width direction of the recording sheet S and four end side driven post-fixing rollers 43b disposed, two by two, on the width direction both end-sides. The driven post-fixing roller 43 is pressed against the driving post-fixing roller 32 by a not shown pressure means such as a spring and is driven by the driving post-fixing roller 42 so as to be rotated. The frictional forces of the end side driving post-fixing rollers 43b are larger than the central driving post-fixing rollers 43a.

As shown in FIGS. 12 and 13, in the fixing unit having the configuration described above, the heating roller 172 is heated by the heater H and feeds the recording sheet S to the post-fixing roller 41 while holding the recording sheet S between itself and pressure roller 173. At this time, the feeding amount of the recording sheet S is smaller at the width direction center portion due to the reversed crown shape of the pressure roller 173 while the feeding amount thereof is larger at the both end-sides. This difference in the feeding amount causes the both end-sides of the recording sheet S to get loose at the downstream side of the pressure roller 173, which may generate wrinkles in the recording sheet S.

Subsequently, the recording sheet S is fed between the driving post-fixing roller 32 and driven post-fixing roller 43 of the post-fixing roller 41. At this time, since the frictional forces of the end side driving post-fixing rollers 42b of the driving post-fixing roller 42 are larger than those of the central driving post-fixing rollers 42a and frictional forces of the end side driven post-fixing rollers 43b of the driven post-fixing roller 43 are larger than those of the central driven post-fixing rollers 43a, the feeding amount of the recording sheet S is larger at the width direction both end-sides. Therefore, looseness of the recording sheet S at both end-sides thereof which is generated between the heating and pressure rollers 172, 173 and post-fixing roller 41 can be reduced.

Although the outer diameters and feeding forces of the end side driving post-fixing rollers 42b are made larger than those of the central driving post-fixing rollers 42a in the above example of the embodiment, the outer diameters and feeding forces of either of the end side driving post-fixing rollers 42b and the end side driven post-fixing rollers 43b may be made larger than those of the central driving post-fixing rollers 42a and the central driven post-fixing rollers 43a.

Further, although the configuration of the fixing unit according to the fourth example is obtained by combining the first through third examples of the first embodiment, the fixing unit according to the first embodiment may be obtained by appropriately selecting two from the above-mentioned examples and combining them. The present invention is not limited to the above embodiment as long as the sheet feeding amount by the end side driving post-fixing rollers are larger than those of the central driving post-fixing rollers.

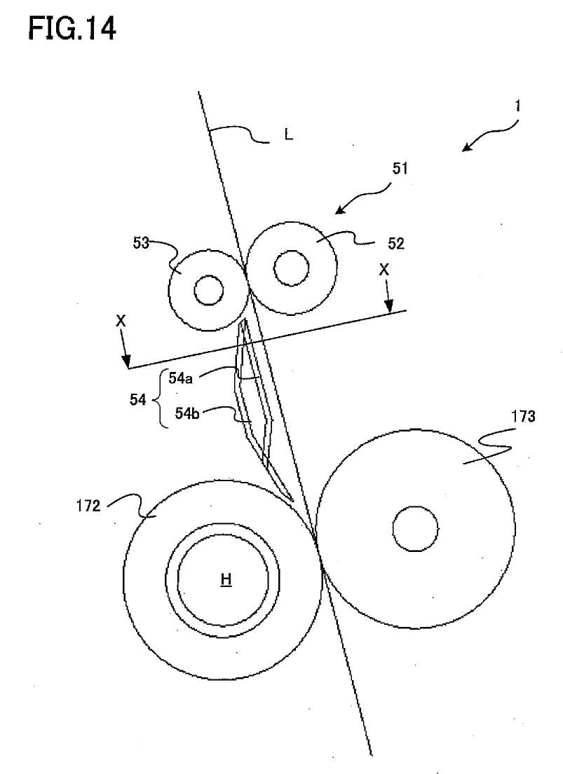

Next, a second embodiment of the present invention will be described with reference to the accompanying drawings. FIG. 14 shows a cross-sectional view of a fixing unit according to the second embodiment. In the drawing, a reference symbol 51 denotes a post-fixing roller, 52 denotes a driving post-fixing roller, 53 denotes a driven post-fixing roller, 54 denotes a post-fixing guide, T denotes a fixing roller, 172 denotes a heating roller, H denotes a heater, and 173 denotes a pressure roller.

The fixing roller T includes the heating roller 172 and pressure roller 173. The heating roller 172 incorporates the heater H and is rotatably supported at its both end portions. The pressure roller 173 is disposed in parallel to the heating roller 172 and has a reversed crown shape in which the outer diameter of each of the both end portions thereof is larger than that of the center portion. Like the heating roller 172, the pressure roller 173 is rotatably supported at its both end portions.

A recording sheet onto which a toner image has been thermally fixed by the heating roller 172 is fed from between the heating roller 172 and pressure roller 173 and, then, is discharged toward the downstream side by the post-fixing roller 51.

The post-fixing guide 54 is disposed between the fixing roller T and post-fixing roller 51. The post-fixing guide 54 has a configuration such that the distance from the recording sheet is larger at the center portion of the post-fixing guide 54 than at the both end-sides thereof. More specifically, width direction guide both end sides 54a are brought close to but not allowed to exceed a fixing nip line L connecting a nip exit of the fixing roller T and nip entrance of the post-fixing roller 51 while a guide center portion 54b is made away from the fixing nip line L than the guide both end sides 54a.

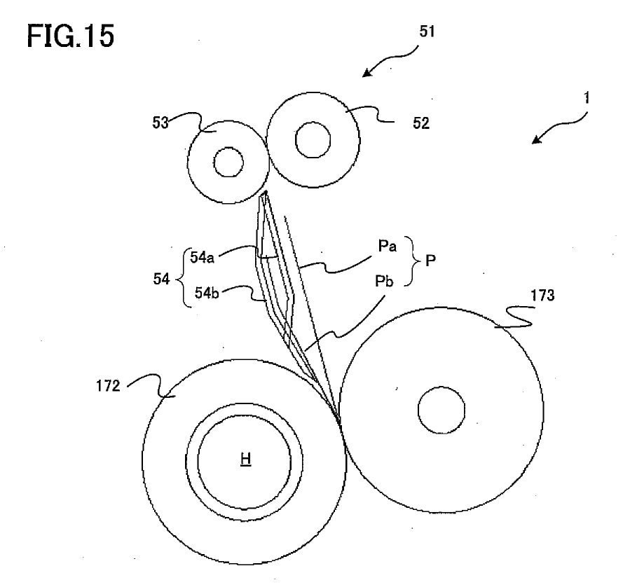

Operation of the fixing unit using the post-fixing guide 54 having such a configuration will next be described. As shown in FIG. 15, since the pressure roller 173 is formed into a reversed crown shape, the feeding speed of the recording sheet at the fixing roller T is larger at the both end portions than at the center portion. Accordingly, after the recording sheet P has passed the fixing roller T, the feeding amount of the recording sheet P is larger at the sheet both end portions Pa than at the sheet center portion Pb. At this time, the sheet center portion Pb swells toward the post-fixing guide 54 along the guide center portion 54b of the post-fixing guide 54 to balance the feeding speed difference of the recording sheet P in the axial direction thereof, thereby reducing waving at the sheet both end portions Pa.

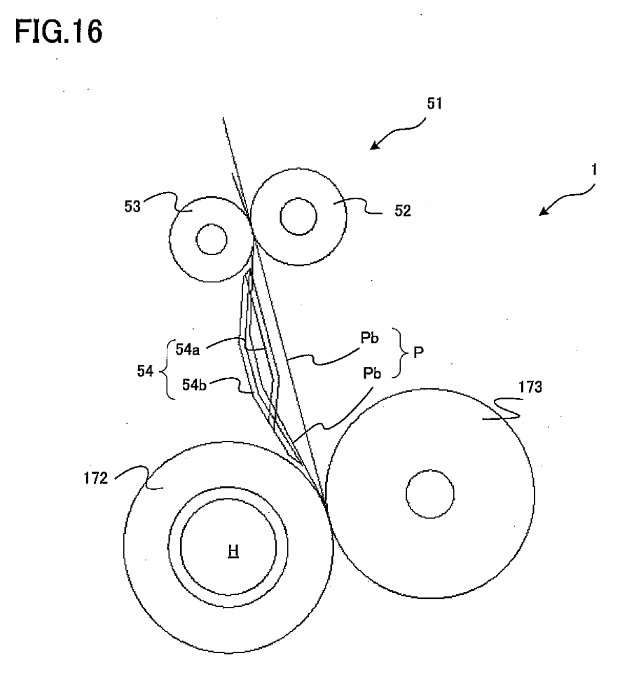

In this state, when the recording sheet P enters the post-fixing roller 51 as shown in FIG. 16, the sheet both end portions Pa first enter the post-fixing roller 51 and, then, the sheet center portion Pb enters the post-fixing roller 51. Then, since the rotational speed of the post-fixing roller 51 is higher than that of the fixing roller T, the sheet both end portions Pa are pulled by the post-fixing roller 51 in advance of the sheet center portion Pb, thereby further reducing the waving.

As described above, with the configuration in which the guide both end sides 54a of the post-fixing guide 54 are brought close to the fixing nip line L while the guide center portion 54b is made away from the fixing nip line L, it is possible to reduce waving at the sheet both end portions Pa.

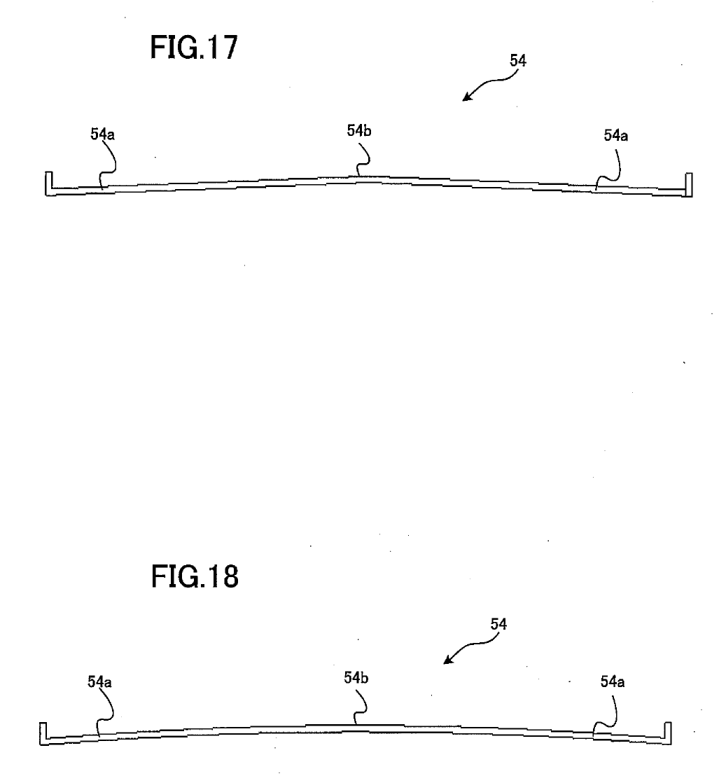

A concrete example of the post-fixing guide 54 will next be described. FIGS. 17 to 20 show cross-sectional views of different examples of the post-fixing guide 54 taken along X-X line of FIG. 14.

FIG. 17 is a cross-sectional view showing a first example of the second embodiment. In this example, as shown in FIG. 17, the post-fixing guide 54 is formed to have a V-shape cross section so that the guide both end sides 54a are brought close to the fixing nip line L while the guide center portion 54b is made away from the fixing nip line L than the guide both end sides 54a. With this configuration, the sheet center portion Pb of the recording sheet P swells toward the post-fixing guide 54 along the guide center portion 54b of the post-fixing guide 54, thereby reducing the waving.

FIG. 18 is a cross-sectional view showing a second example of the second embodiment. In this example, as shown in FIG. 18, the cross-section of the post-fixing guide 54 is curved so that the guide both end sides 54a are brought close to the fixing nip line L while the guide center portion 54b is made away from the fixing nip line L than the guide both end sides 54a. With this configuration, the sheet center portion Pb of the recording sheet P swells toward the post-fixing guide 54 along the guide center portion 54b of the post-fixing guide 54, thereby reducing the waving.

As described above, the cross-section of the post-fixing guide 54 is formed into a V-shape or curved, thereby reducing waving at the sheet both end portions Pa with a simple structure and at low cost.

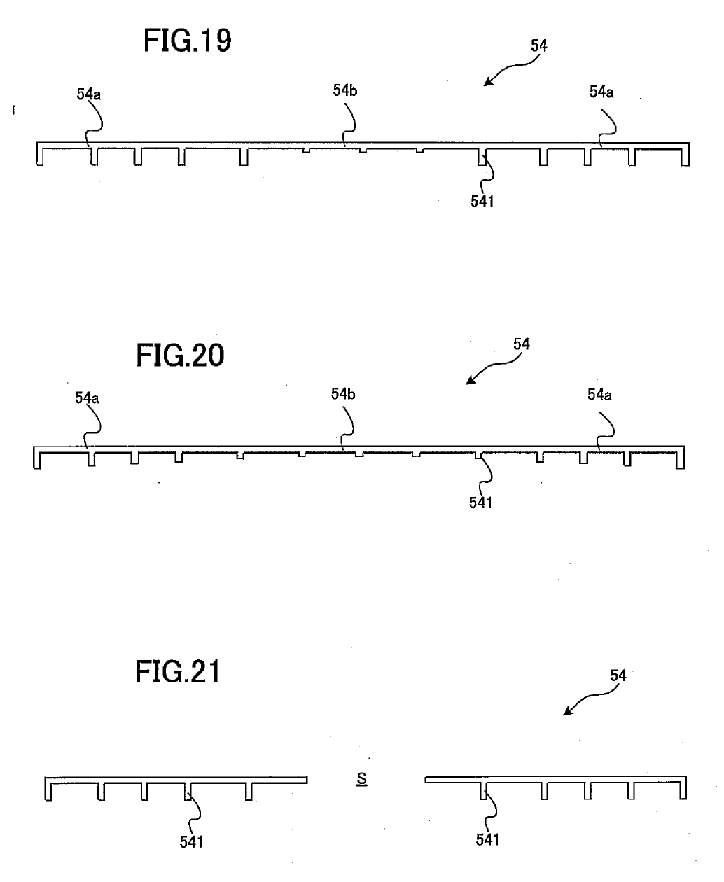

FIG. 19 is a cross-sectional view showing a third example of the second embodiment. In this example, as shown in FIG. 19, ribs 541 are formed on the post-fixing guide 54 such that the ribs 541 on the guide both end sides 54a are formed longer so as to come close to the fixing nip line L while the ribs 541 on the guide center portion 54b are formed shorter than the guide both end sides 54a so as to be away from the fixing nip line L. With this configuration, the sheet center portion Pb of the recording sheet P swells toward the post-fixing guide 54 along the guide center portion 54b of the post-fixing guide 54, thereby reducing the waving. Although the ribs 541 are formed on the guide center portion 54b and the lengths thereof are made shorter than those formed on the guide both end sides 54a in this example, the ribs 541 need not be formed on the guide center portion 54b.

FIG. 20 is a cross-sectional view showing a fourth example of the second embodiment. In this example, as shown in FIG. 20, the ribs 541 are formed on the post-fixing guide 54, and the ribs 541 on the guide both end sides 54a are gradually made longer toward the outermost end portions so as to come close to the fixing nip line L while the ribs 541 on the guide center portion 54b are gradually made shorter toward the center so as to be away from the fixing nip line L. With this configuration, the sheet center portion Pb of the recording sheet P swells toward the post-fixing guide 54, thereby reducing the waving.

As described above, the ribs 541 are formed on the post-fixing guide 54 such that the ribs 541 on the guide both end sides 54a are formed longer so as to come close to the fixing nip line L while the ribs 541 on the guide center portion 54b are formed shorter so as to be away from the fixing nip line L, thereby reducing waving at the sheet both end portions Pa while maintaining the strength of the post-fixing guide 54.

FIG. 21 is a cross-sectional view showing a fifth example of the second embodiment. In this example, as shown in FIG. 21, the post-fixing guide 54 is divided into two parts respectively on the width direction end sides with a space S formed between them. The ribs 541 are formed on the post-fixing guide 54. With this configuration, the sheet center portion Pb of the recording sheet P swells toward the post-fixing guide 54 along the space S, thereby reducing the waving. Although the ribs 541 are formed on the post-fixing guide 54 in this example, the ribs need not be provided as long as there is the space S along which the recording sheet P can swell at the center. Further, two post-fixing guides 54 may be inclined or curved so as to be easily separated from each other.

As described above, the post-fixing guide 54 is divided into two parts respectively on the width direction end sides and, therefore, yield is improved to reduce cost.

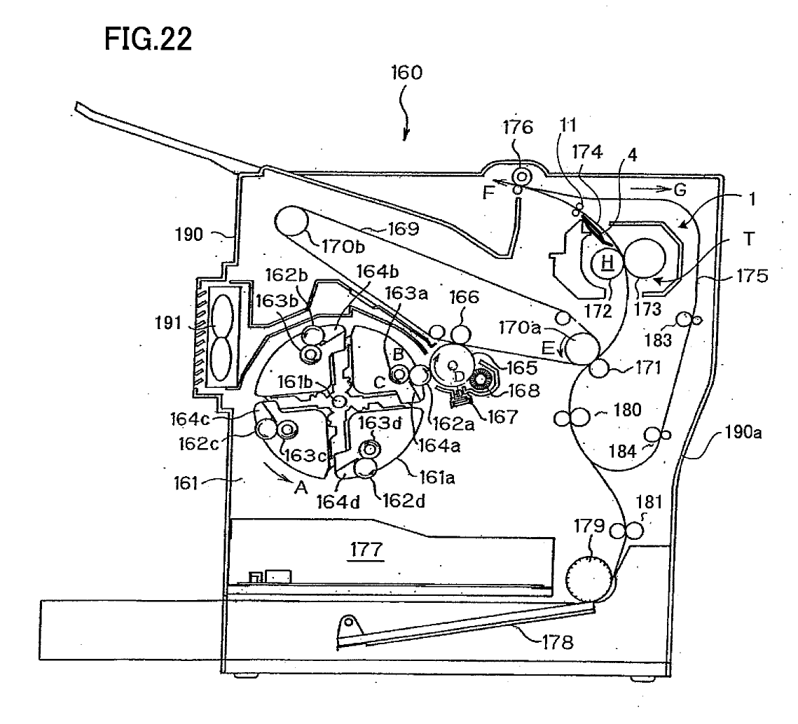

FIG. 22 is a vertical cross-sectional side view of an image forming apparatus to which the present invention is applied. In FIG. 22, an image forming apparatus 160 includes, as main component parts thereof, a rotary-type developing unit 161, a photosensitive drum 165 functioning as an image carrier, an image writing means (line head) 167 having an organic EL array, an intermediate transfer belt 169 serving as an intermediate transfer member, a sheet feeding path 174, a heating roller 172 of the fixing unit, and a sheet supply tray 178.

In the developing unit 161, a developing rotary 161a is rotated in the direction of an arrow A about a shaft 161b. The inside of the developing rotary 161a is divided into four parts in which image forming units of four colors (yellow (Y), cyan (C), magenta (M), and black (K)) are respectively provided. Reference symbols 162a to 162d denote developing rollers serving as toner carriers which are respectively provided in the image forming units of four colors and which are rotated in the direction of an arrow B. Reference numerals 163a to 163d denote toner supply roller which are rotated in the direction of an arrow C. Reference numerals 164a to 164d are restricting blades for restricting the thickness of toner.

The photosensitive drum 165 is driven by a not shown driving motor such as a stepping motor in the direction of an arrow D which is opposite direction to the rotational direction of the developing roller 162a. The intermediate transfer belt 169 is wound around a driven roller 170b and a driving roller 170a. The driving roller 170a is connected to a driving motor of the photosensitive drum 165, thereby providing a driving force to the intermediate transfer belt 169. The drive of the driving motor causes the driving roller 170a of the intermediate transfer belt 169 to be rotated in the direction of an arrow E which is opposite direction to the rotational direction of the photosensitive drum 165.

In the image forming apparatus having such a configuration, a toner transfer operation between the developing unit 161 and intermediate transfer belt 169 of the image forming apparatus 160 is carried out as follows. Toner is supplied from the toner supply roller 163 to the developing roller 162. At this time, toner amount is controlled by the restricting blade 164. The developing roller 162 develops a latent image on the photosensitive drum 165 formed by the line head 167 and the like. The developed image on the photosensitive drum 165 is transferred to the intermediate transfer belt 169.

A plurality of feeding rollers, a pair of discharging rollers 176, and the like are provided along the sheet feeding path 174 along which the recording sheet is fed. A single-side image (toner image) carried on the intermediate transfer belt 169 is transferred onto one surface of the recording sheet at the position of a secondary transfer roller 171. The secondary transfer roller 171 comes into contact with or is separated from the intermediate transfer belt 169 by a clutch. When the clutch is turned on, the secondary transfer roller 171 comes into contact with the intermediate transfer belt 169 such that the image is transferred onto the recording sheet.

Then, a fixing process is performed on the recording sheet S having the image transferred thereon by the fixing unit 1 having the heater H. The fixing unit 1 is provided with the heating roller 172 and reversed crown shaped pressure roller 173. After the fixing process, the recording sheet S is fed in the downstream direction by the pair of post-fixing rollers 11 and then pulled by the pair of discharging rollers 176 so as to be transferred in the direction of an arrow F. In this state, when the discharging rollers 176 rotate in the opposite direction to reverse the sheet feeding direction, the recording sheet S passes through a double side printing feeding path (double-side feeding path) 175 in the direction of an arrow G. A reference numeral 183 denotes a pair of first double side rollers, 184 denotes a pair of second double side rollers, 177 denotes an electric component box, 178 denotes a sheet supply tray for storing the recording sheet S, 179 denotes a pick-up roller provided at the outlet of the sheet supply tray 178. An exhaust fan 191 is provided in a housing case 190. An openable cover 190a for pulling out a jammed recording sheet S is formed on the sheet feeding path 174 side of the housing case 190.

A pair of feeding rollers 181 are provided along the sheet feeding path 174 for single side printing on the sheet feeding downstream side relative to the pick-up roller 179. Further, a pair of gate rollers 180 are provided on the sheet feeding direction upstream side relative to the secondary transfer roller 171. In place of the line head 167 using a light-emitting device as an exposure means shown in the example of FIG. 22, a scanning optical system using a laser light as a light source may be provided.

As described above, according to the fixing unit and image forming apparatus using the fixing unit of the present embodiments, waving of a recording sheet caused due to the fixing roller having a reversed crown shape can be reduced.

Although the case where the present invention is applied to a heating roller fixing type fixing unit including the heating roller 172 and pressure roller 173 has been explained in the above embodiment, the present invention can be applied to a fixing unit of a contact heating fixing system in which, for example, a belt is used as one of a heating means and pressing means. In this case, as a matter of course, the same advantage can be obtained.

Although the fixing unit and image forming apparatus using the fixing unit according to the embodiments of the present invention have been shown and described, the present invention is not limited to the above embodiments, and various modifications may be made without departing from the spirit and scope of the present invention.

What is claimed is:

1. A fixing unit comprising:
fixing means including a heating rotator having a heat generator and a pressure rotator which is so disposed opposite to the heating rotator as to form a nip portion, at least one of the heating rotator and pressure rotator having a reversed crown shape; and
a post-fixing roller which is disposed on the downstream side relative to the heating rotator and pressure rotator, wherein
the feeding force of the post-fixing roller is larger at the width direction both end-sides of the post-fixing roller than at the center portion thereof.

2. The fixing unit according to claim 1, wherein
the post-fixing roller has both-end-side post-fixing rollers respectively disposed on its width direction both end-sides and central post-fixing rollers disposed at its width direction center portion, and
the arrangement interval of each of the both-end-side post-fixing rollers is smaller than that of the central post-fixing rollers.

3. The fixing unit according to claim 1, wherein
the post-fixing roller has both-end-side post-fixing rollers respectively disposed on its width direction both end-sides and central post-fixing rollers disposed at its width direction center portion, and
the outer diameters of the both-end-side post-fixing rollers are larger than those of the central post-fixing rollers.

4. The fixing unit according to claim 1, wherein
the post-fixing roller has both-end-side post-fixing rollers respectively disposed on its width direction both end-sides and central post-fixing rollers disposed at its width direction center portion, and
the frictional forces of the both-end-side post-fixing rollers are larger than those of the central post-fixing rollers.

5. The fixing unit according to claim 1, wherein
the post-fixing roller has both-end-side post-fixing rollers respectively disposed on its width direction both end-sides and central post-fixing rollers disposed at its width direction center portion, and
the nip pressures of the both-end-side post-fixing rollers are larger than those of the central post-fixing rollers.

6. A fixing unit comprising:
fixing means including a heating rotator having a heat generator and a pressure rotator which is so disposed opposite to the heating rotator as to form a nip portion, at least one of the heating rotator and pressure rotator having a reversed crown shape;
a post-fixing roller which is disposed on the downstream side relative to the fixing means; and
a post-fixing guide disposed between the fixing means and post-fixing roller, wherein
the post-fixing guide has a configuration such that the distance from a fixing nip line connecting a nip exit of the fixing means and nip entrance of the post-fixing roller is larger at the center portion of the post-fixing guide than at the both end-sides thereof.

7. The fixing unit according to claim 6, wherein
the post-fixing guide has a cross-section having a shape such that the distance from a fixing nip line connecting a nip exit of the fixing means and nip entrance of the post-fixing roller is larger at the center portion of the post-fixing guide than at the both end-sides thereof.

8. The fixing unit according to claim 6, wherein
the post-fixing guide has, at is center portion, a space allowing for deflection of a transfer medium.

9. The fixing unit according to claim 6, wherein
the post-fixing guide has ribs on the guide both end-sides.

10. The fixing unit according to claim 9, wherein
the ribs are also provided on the guide center portion, and
the length of the ribs on the guide both end-sides are longer than those of the ribs on the guide center portion.

11. An image forming apparatus using the fixing unit as claimed in claim 1 or 6, comprising:
an image carrier;
a developer carrier for developing a latent image on the image carrier;
an intermediate transfer member for transferring the image on the image carrier developed by the developer carrier;
a secondary transfer section for transferring the image on the intermediate transfer member onto a transfer medium; and
the fixing unit for fixing the image on the transfer medium.
